(19) United States
(12) Patent Application Publication
(10) Pub. No.: US 2006/0208886 A1
(43) Pub. Date: Sep. 21, 2006

(54) Systems and methods for providing packages with RFID tags

(75) Inventor: Brent Beamer, Cary, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/069,669

(22) Filed: Mar. 1, 2005

(51) Int. Cl. G08B 13/14

(52) U.S. Cl. 340/572.1

(57) ABSTRACT

A method of forming a package includes forming a container comprising an RF blocking or attenuating material or intended to store an item comprising an RF blocking or attenuating material, and permanently attaching a radio frequency identification (RFID) tag to the container. The RFID tag includes an antenna held in a position at least partially extending outward from the container such that the antenna is not shielded from RF signals by any metal components of the container or any metal held in the container. In another aspect, a package includes a container comprising an RF blocking or attenuating material or intended to store an item comprising an RF blocking or attenuating material. The package also includes a radio frequency identification (RFID) tag permanently affixed to the container. The RFID tag includes an antenna held in a position at least partially extending outward from the container.

### BACKGROUND

The present invention generally relates to the packaging and tracking of containers, and more particularly to apparatus and techniques for attaching a radio frequency identification (RFID) tag to a container or package.

There is a widespread need to track and identify a variety of items in the normal course of business operations. For example, in a company's supply chain, the capability to readily identify and track items can decrease the time to market, increase efficiency, decrease costs, and provide a host of other advantages. One solution to such a need is an RFID tag tracking system in which an RFID tag is attached to each of the items to be tracked. A typical passive RFID tag tracking system comprises the RFID tags and an interrogator, also known as a reader. The RFID tag includes an antenna and a microchip, which may store data such as a serial number or an item identification number. To read the data stored on the microchip, the interrogator transmits electromagnetic radio frequency (RF) waves to the RFID tag. The antenna of the RFID tag receives these broadcast electromagnetic RF waves and the small electrical current induced in the antenna is used to power the microchip. Once appropriately powered, the RFID tag then modulates the received RF waves to send data, such as the serial number, to the interrogator.

Unlike a bar code read by an optical scanner, an RFID tag tracking system does not depend upon an unobstructed line of sight from the reader to the item to be read since RF signals pass through many types of materials. However, RF signals can be blocked or interfered with by some types of materials, such as metals and liquids. These materials, which may be present in the packaging of the item, the item itself or other external items, may prevent reliable communication between the interrogator and the RFID tag attached to a side of the package by blocking or substantially attenuating. Therefore, it would be advantageous to provide systems and methods for attaching an RFID tag to a package which allows the RFID tag to be read when the package comprises an RF blocking, or attenuating material or the package is holding an item comprising an RF blocking or attenuating material.

### SUMMARY

In one aspect of the present invention, a method of forming a package includes forming a container comprising an RF blocking material or intended to store an item comprising an RF blocking material, and permanently attaching a radio frequency identification (RFID) tag to the container. The RFID tag includes an antenna held in a position at least partially extending outward from the container such that the antenna is not shielded from RF signals by any RF blocking components of the container or any RF blocking material held in the container.

In another aspect of the present invention, a package includes a container comprising an RF blocking material or intended to store an item comprising an RF blocking material. The package also includes a radio frequency identification (RFID) tag permanently affixed to the container. The RFID tag includes an antenna held in a position at least partially extending outward from the container.

A more complete understanding of the present invention, as well as further features and advantages of the invention, will be apparent from the following detailed description and the accompanying drawings.

### BRIEF DESCRIPTION OF THE DRAWINGS

FIG. 1 shows a block diagram of an RFID tag suitable for use with the present invention;

FIG. 2 shows a block diagram of an interrogator for reading an RFID tag suitable for use with the present invention;

FIG. 3 shows perspective views of an RFID tag flag in accordance with the present invention;

FIG. 4 shows a perspective view of an RFID tag flag attached to a package in accordance with the present invention;

FIG. 5 shows a perspective view of an alternate embodiment of an RFID tag flag attached to a package in accordance with the present invention;

FIG. 6 shows a perspective view of an alternate embodiment of an RFID tag flag attached to a package in accordance with the present invention;

FIG. 7 shows a perspective view of an RFID tag attached to a lip of a package in accordance with the present invention;

FIG. 8 shows a perspective view of an exemplary process of forming a package including an attached RFID tag or RFID tag flag in accordance with the present invention;

FIGS. 9 and 10 show perspective views of a box having an attached RFID tag flag in accordance with the present invention; and

FIG. 11 shows an exemplary simplified technique for forming box having an attached RFID tag or RFID tag flag in accordance with the present invention.

### DETAILED DESCRIPTION

The following detailed description of preferred embodiments refers to the accompanying drawings which illustrate specific embodiments of the invention. In the discussion that follows, specific systems and techniques for manufacturing or forming a package including an attached RFID tag are disclosed. Other embodiments having different structures and operations for the manufacture of other types of packages or containers including an attached RFID tag do not depart from the scope of the present invention.

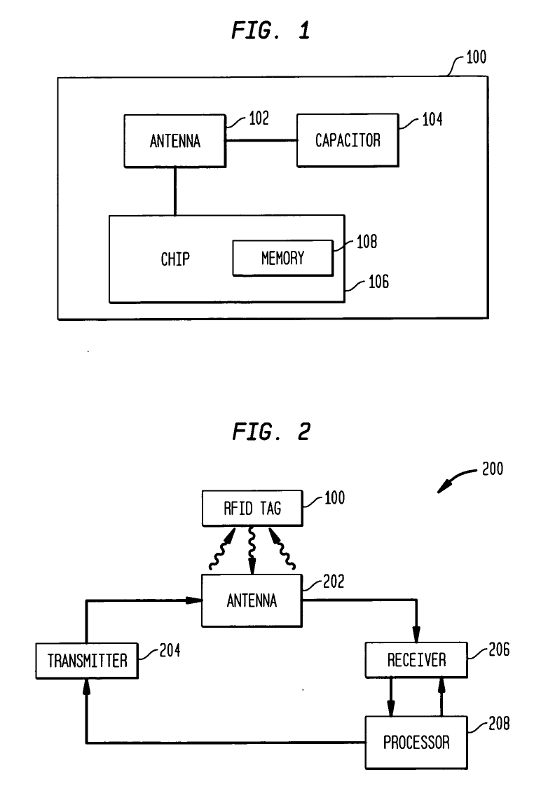

FIG. 1 shows a block diagram of an exemplary RFID tag 100 suitable for use in conjunction with the present invention. The RFID tag 100 comprises a coil antenna 102 connected to a capacitor 104 to form a resonant circuit. The resonant circuit is activated by a particular broadcast frequency which is transmitted from a reader 200 described below. Connected to the antenna is a chip 106 (also known as an integrated circuit) which is powered by the voltage generated in the antenna by the broadcast frequency. The chip 106 includes a memory element 108 storing data, such as an identification number. When the chip is activated and powered by the received frequency, the chip changes the load resistance of antenna 102 to communicate the data to the reader 200.

FIG. 2 shows a block diagram of the reader 200 communicating with the RFID tag 100 in accordance with the present invention. As shown in FIG. 2, the reader 200, or interrogator, comprises an antenna 202, a transmitter 204, a receiver 206 and a processor 208 which controls the operation of the reader 200. To read from the RFID tag 100, the processor directs the transmitter 204 to transmit the broadcast frequency to the RFID tag 100 through the antenna 202. As described above, the RFID tag 100 transmits the data stored in the memory 108 by changing the load resistance in its antenna 102, which in turn changes the voltage of the antenna 202 of the reader 200. The receiver 206 detects this voltage change and passes the data to the processor 208 for further use. Such a system is known as an inductive coupling system. Other techniques, such as backscatter coupling, for example, may also be used in conjunction with the present invention.

As described above, certain materials, such as metal foil in a package an RFID tag is attached to or metal contents of the package itself, may interfere with the broadcast frequency or the ensuing response in an RFID tracking system. The present invention provides techniques for attaching an RFID tag to a package to ensure that at least a portion of the antenna of the RFID tag extends outward from the package to prevent the package or its contents from hindering the operation of the tracking system by interfering with or substantially attenuating a signal broadcast from an interrogator (or the ensuing response).

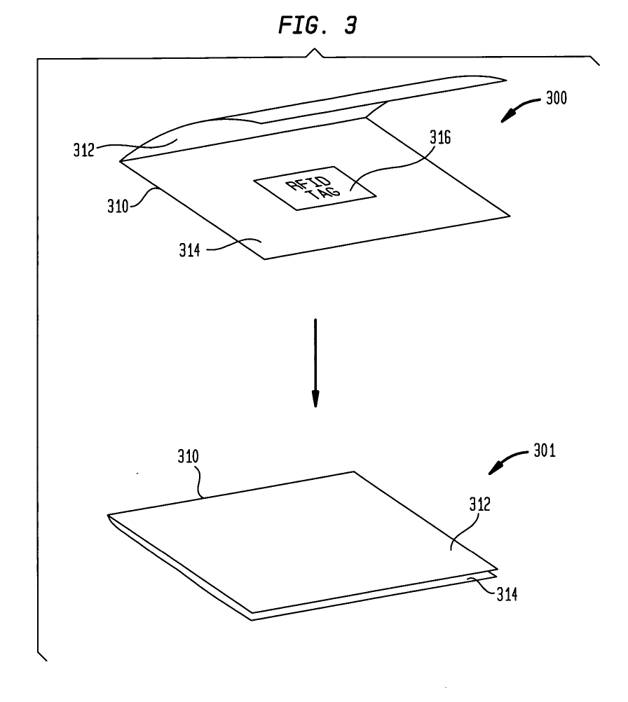

FIG. 3 shows a RFID tag flag 310 suitable for attachment to a package or container in accordance with the present invention. As seen in view 300, an RFID tag 316 may be affixed to a first sheet 314 by a variety of techniques, such as utilizing an adhesive, for example. In one aspect of the present invention, the RFID tag 316 may be sealed between the first sheet 314 and a second sheet 312 using techniques such as heat or adhesive lamination. As seen in views 310 and 312, the first sheet 314 and second sheet 312 may be formed from a single sheet which is folded over the RFID tag 316 along an edge of the RFID tag flag 310. Either the first sheet 314, the second sheet 312, or both sheets may comprise a nonmetallic material, such as heat sealable plastic. This plastic may be transparent or colored. In an alternate embodiment, the RFID tag 316 may be affixed to only a single sheet.

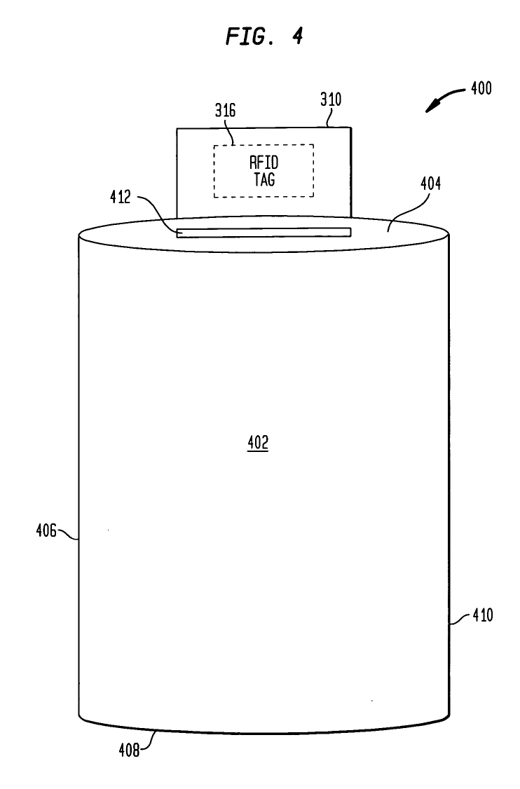

FIG. 4 shows a perspective view of a package 400 in accordance with the present invention. In this exemplary embodiment, the package 400 may suitably comprise a container such as a bag 402 having an opening 404 and being sealed around edges 406, 408 and 410. The bag 402 may include an RF blocking material, such as metal, for example, in its structure or may be intended to store items comprising an RF blocking material. According to one aspect of the present invention, the bag 402 may comprise a static electricity shielding material to protect sensitive electronic devices contained therein from electrostatic discharge and the resulting electrical damage. In another aspect of the present invention, the bag 402 may be intended to hold an RF blocking material. In another aspect, the bag 402 may comprise foil to prevent spoilage of perishable items, such as food, intended to be stored therein. To prevent such metal or other RF blocking material from blocking or attenuating a signal to or from an RFID tag, the RFID tag flag 310 may be attached to the bag 402 such that the RFID tag 316 is held in a position extending outward from the bag 402. Thus, the RFID tag flags 310 are not blocked by other bags when the package 400 is stacked on other similar packages. The RFID tag flag 310 may be permanently affixed to the bag 402 by a variety of suitable techniques, such as, for example, adhering or heat sealing the RFID tag flag 310 to the interior or exterior of the bag 402 along section 412 adjacent to the opening 404.

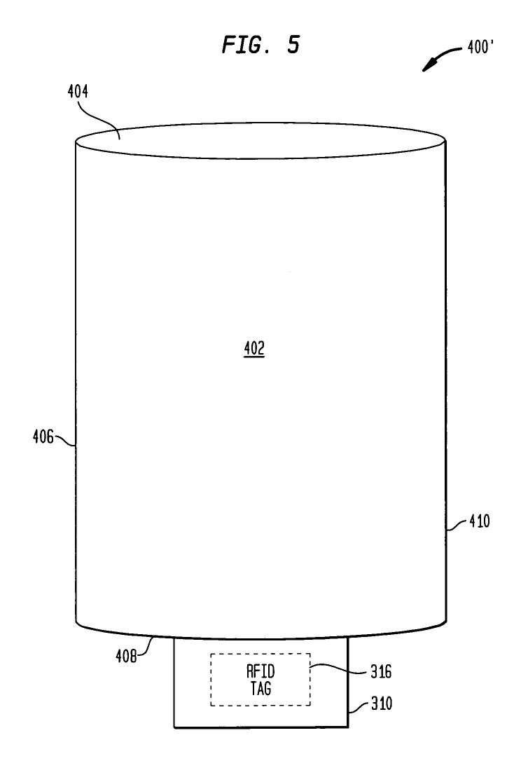

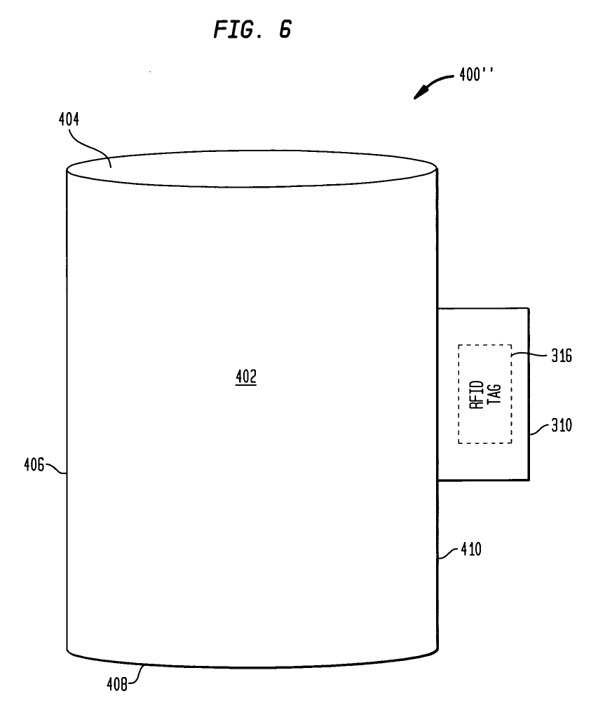

In alternate embodiments, as shown in FIGS. 5 and 6, the RFID tag flag 310 may be affixed to other surfaces or edges of the bag 402 to form the packages 400′ and 400″ in accordance with the present invention. FIG. 5 shows the RFID tag flag 310 extending outward from bottom edge 408 of the bag 402 to form the package 400′. FIG. 6 shows the RFID tag flag extending outward from side edge 410 of the bag 402 to form the package 400″.

In one aspect of the present invention, only a portion of the RFID tag 316 extends outward from the bag 402. In another aspect of the present invention, at least a portion of the antenna of the RFID tag 316 extends outward from the bag 402. As described in greater detail below, the RFID tag flag 310 may be attached to the bag 402 during the manufacture of the bag 402.

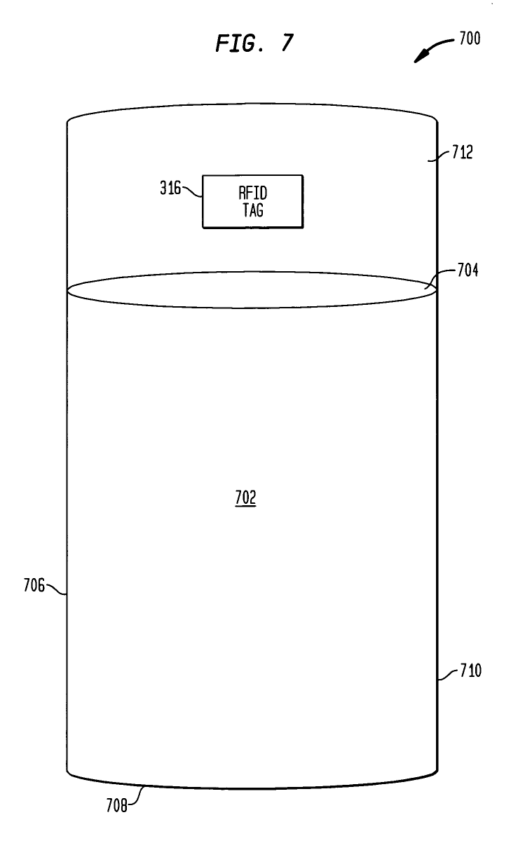

FIG. 7 shows a perspective view of a package 700 in accordance with the present invention. In this embodiment, the package 700 may suitably comprise a container such as a bag 702 having an opening 704 and being sealed around edges 706, 708 and 710. The bag 702 also includes a flap 712 extending outward from the bag 702. The flap 712 may suitably comprise a non-metallic material, such as plastic, which does not significantly block or attenuate RF signals. The bag 702, with the exception of the flap 712, may include metal (or other RF blocking or attenuating material) in its structure or may be intended to store items comprising metal. To prevent such metal from blocking a signal to or from an RFID tag, the RFID tag 316 may be attached to the flap 712 of the bag 702 such that the RFID tag 316 extends outward from the bag 702. The RFID tag 316 permanently affixed to the bag 702 by a variety of suitable techniques, such as, for example, adhering or heat sealing the RFID tag 316 to the flap 712. The flap 712 may be a contiguous part of the package 700, with the flap 712 constructed without RF blocking material.

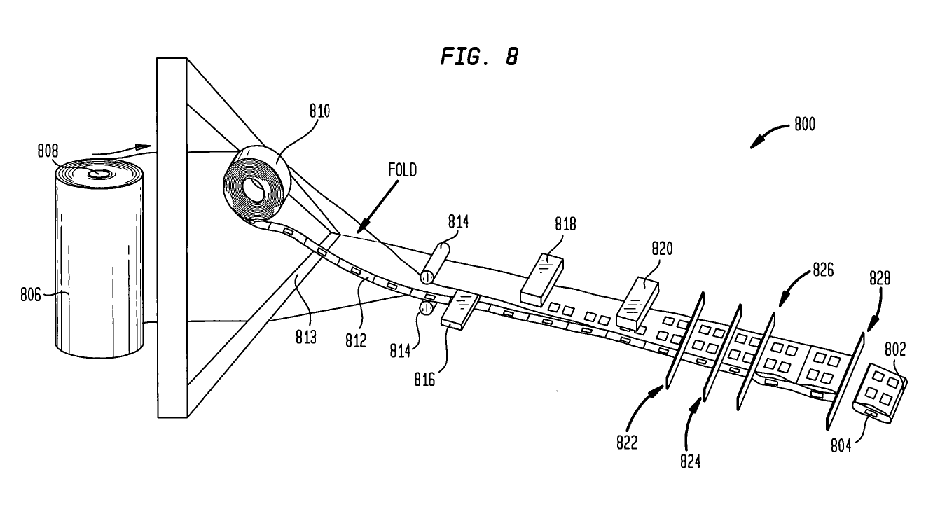

FIG. 8 shows a perspective view of an exemplary process of forming a bag 802 including an RFID tag 804 utilizing a bag forming machine 800 in accordance with the present invention. A plastic film 806 wound onto a roll 808 and a reel 810 of RFID tag flags 812 may be suitably installed on the bag forming machine 800. The plastic film may be a multi-layer structure and include a metallic layer. In a preferred embodiment the reel 810 comprises a plurality of RFID tags 804 placed on a continuous ribbon of heat sealable plastic. The RFID tags 804 are separated from each other in the ribbon material by a distance appropriate for the width of the bag to be produced. To form the bag 802, the plastic film 806 is pulled from the roll 808 and folded around a folding board 812 and passed through rollers 814 which hold the two sides of the bag in proximity to each other. A heat sealing device 816 may heat seal the ribbon of RFID tag flags 812 along an edge of the folded plastic film 806. A label printing device 818 and a hot stamp device 820 may be utilized to print or stamp any desired markings on the plastic film. As understood by one of ordinary skill in the art, the bags may be formed by seal heads 822 and 824 that reflow the plastic and cause a joint, or seal, to occur. A cold bar 826 removes heat from the seal to allow cutting. A cutting head 828 may be used to form the bags 802 by cutting along the seal formed by the seal heads 822 and 824. The cutting head 828 may also cut the ribbon material of the RFID tag flags 812, previously affixed to the bags 802. Thus, each bag 802 is formed with a permanently attached and integrated RFID tag 804 which extends outward from the bag so as not to be blocked by any RF blocking material. The permanently attached RFID tags 804 may be used to track each of the bags (and therefore the contents of the bags) throughout the useful life of the bags 802.

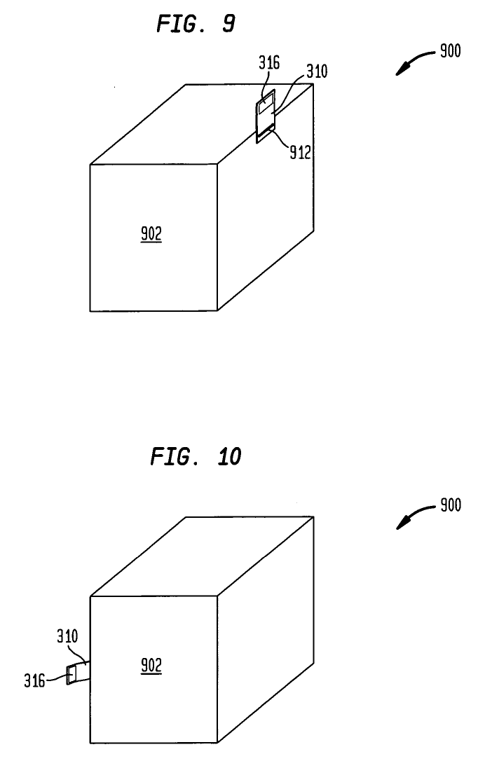

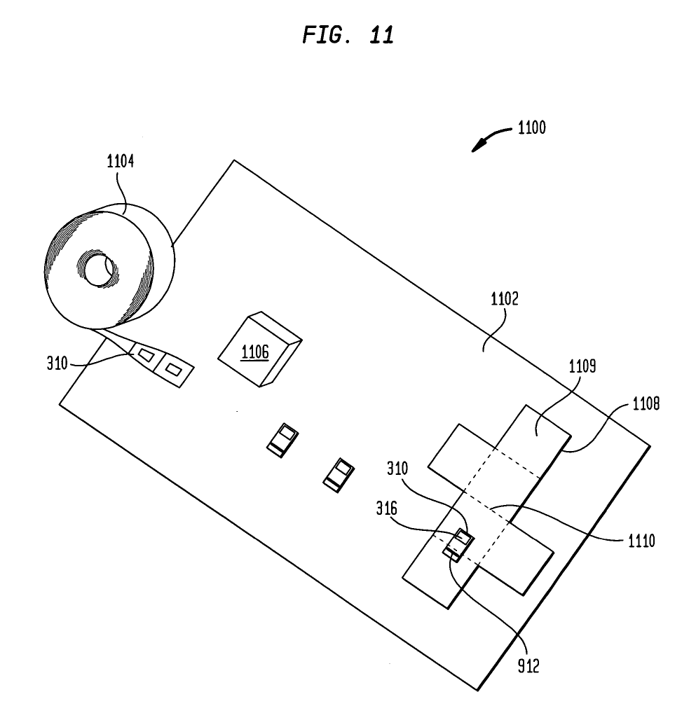

In another aspect of the present invention, an RFID tag flag may be attached to a box. FIGS. 9 and 10 show perspective views of a package 900 in accordance with one aspect of the present invention. In this exemplary embodiment, the package 900 may suitably comprise a container such as a box 902. The box 902 may include an RF blocking material, such as metal, for example, in its structure or may be intended to store items comprising an RF blocking material. To prevent such metal or other RF blocking material from blocking or attenuating a signal to or from an RFID tag, the RFID tag flag 310 may be attached to the box 902 such that the RFID tag 316 is held in a position extending outward from the box 902. Thus, the RFID tag flags 310 are not blocked by other bags when the package 900 is stacked along side other similar packages. The RFID tag flag 310 may be affixed to the box 902 by a variety of suitable techniques, such as, for example, adhering the RFID tag flag 310 to box 902 along section 912 adjacent to an edge of the box 902.

FIG. 11 shows an exemplary simplified technique 1100 for forming the package 900 from a section of cardboard 1102 in accordance with the present invention. A reel 1104 comprises a plurality of RFID tags 310. An applicator 1106 adheres the RFID tag flags 310 to the cardboard 1102 in a predetermined position. The cardboard 1102 may then be cut along solid lines 1108 to form a cutout section 1109 of the box 902. The cutout section 1104 may then be folded along dotted lines 1110 to form the box 902. Due to the RFID tags being attached to the cardboard 1102 along section 912, when the cutout section is folded along the lines 1110, the RFID tag 310 extends outward from the box 902 as shown in FIGS. 9 and 10.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of forming a package comprising:
forming a container, said container comprising a material that substantially attenuates radio frequency (RF) signals or intended to store an item comprising a material that substantially attenuates RF signals; and
permanently attaching a radio frequency identification (RFID) tag to the container, said RFID tag comprising an antenna held in a position at least partially extending outward from the container.

2. The method of claim 1 wherein the antenna is held in a position such that the container or items stored in the container do not substantially attenuate RF signals to prevent operation the RFID tag.

3. The method of claim 1 further comprising:
forming an RFID tag flag comprising the RFID tag affixed to at least one nonmetallic sheet, and
wherein the step of permanently attaching further comprises attaching the RFID tag flag to the container such that the antenna is held in a position at least partially extending outward from the container.

4. The method of claim 3 wherein the step of permanently attaching further comprises:
affixing the RFID tag flag along an edge of the container.

5. The method of claim 3 wherein the RFID tag flag comprises the RFID tag sealed between two nonmetallic sheets.

6. The method of claim 1 wherein the RFID tag is attached to the container during the process of forming the container.

7. The method of claim 1 wherein the container comprises a nonmetallic lip extending outward from the container and the step of permanently attaching further comprises:
affixing the RFID tag to the nonmetallic lip.

8. The method of claim 1 wherein the container comprises a nonmetallic lip extending outward from the container and the step of permanently attaching further comprises:
embedding the RFID tag in the nonmetallic lip.

9. A package comprising:
a container comprising a material that substantially attenuates radio frequency (RF) signals or intended to store an item comprising a material that substantially attenuates RF signals; and
a radio frequency identification (RFID) tag permanently affixed to the container, said RFID tag comprising an antenna held in a position at least partially extending outward from the container.

10. The package of claim 9 wherein the antenna is held in a position such that the container or items stored in the container do not substantially attenuate RF signals to prevent operation the RFID tag.

11. The package of claim 9 further comprising an RFID tag flag comprising the RFID tag affixed to at least one nonmetallic sheet, said RFID tag flag attached to the container such that the antenna is held in a position at least partially extending outward from the container.

12. The package of claim 11 wherein the RFID tag flag is affixed along an edge of the container.

13. The package of claim 11 wherein the RFID tag flag comprises the RFID tag held between two nonmetallic sheets.

14. The package of claim 9 wherein the RFID tag is attached to the container during the process of forming the container.

15. The package of claim 9 wherein the container comprises a nonmetallic lip extending outward from the container and the RFID tag is affixed to the nonmetallic lip.

16. A package comprising:
a container adapted for protecting items disposed within the container from electrostatic discharge; and
a radio frequency identification (RFID) tag attached to the container and comprising an antenna at least partially extending outward from the container.

17. The package of claim 16 further comprising an RFID tag flag comprising the RFID tag affixed to at least one nonmetallic sheet, said RFID tag flag attached to the container.

18. The package of claim 16 wherein the container comprises a nonmetallic lip extending outward from the container and the RFID tag is affixed to the nonmetallic lip.

19. The package of claim 16 wherein the container comprises an edge and wherein the RF antenna at least partially extends outward from the edge of the container.
